(19) United States
(12) Patent Application Publication
(10) Pub. No.: US 2012/0291082 A1
(43) Pub. Date: Nov. 15, 2012

(54) MULTIMEDIA FILE PLAYING SYSTEM, METHOD AND SET-TOP BOX

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 13/191,463

(22) Filed: Jul. 27, 2011

(30) Foreign Application Priority Data
May 13, 2011 (TW) 100116870

(51) Int. Cl. H04N 7/173

(52) U.S. Cl. 725/110

(57) ABSTRACT

A set-top box is provided. The set-top box includes a network interface, a wireless communication unit, and a processor. The set-top box connects to a network server through the network interface. The set-top box communicates with a portable device. The processor receives a play request signal including at least one keyword from the portable device through the wireless communication unit. Searches the network server to find at least one multimedia file through the network interface according to the at least one keyword included in the play request signal. Downloads the at least one multimedia file found from the network server, and transmits the downloaded portion of the at least one multimedia file to the portable device through the wireless communication unit.

### BACKGROUND

1. Technical Field

The present disclosure relates to multimedia file playing systems, methods and set-top boxes and, particularly, to a multimedia file playing system capable of using a portable device to play the multimedia file and methods.

2. Description of Related Art

Set-top boxes can download multimedia files from the network. The downloaded multimedia files are usually played through digital televisions. As the digital televisions are inconvenient to carry around, users cannot readily view the multimedia files from a different location.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram showing a multimedia file playing system connected to a network server, in accordance with an exemplary embodiment.

FIG. 2 is a block diagram of the multimedia file playing system of FIG. 1, in accordance with an exemplary embodiment.

FIG. 3 is a flowchart of a multimedia file playing method in accordance with an exemplary embodiment.

### DETAILED DESCRIPTION

Embodiments of the present disclosure are now described in detail, with reference to the accompanying drawings.

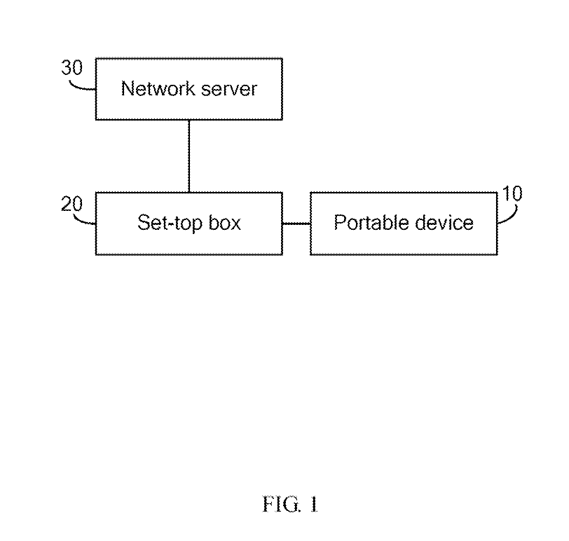

Referring to FIG. 1, a multimedia file playing system 1 includes at least one portable device 10 and a set-top box 20. The set-top box 20 downloads the at least one multimedia file from a network server 30 according to user input, and transmits the at least one multimedia file to the at least one portable device 10 to display/play. For simplicity, one portable device 10 is employed to illustrate the present disclosure. The portable device 10 may be a mobile phone, a wrist worn device, or an E-book.

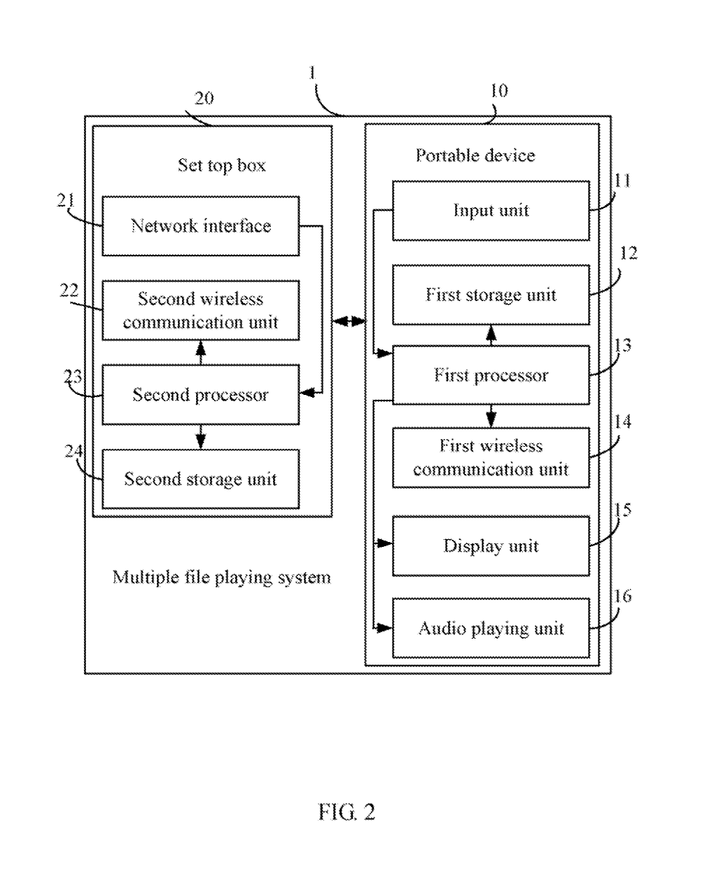

Referring to FIG. 2, the portable device 10 includes an input unit 11, a first storage unit 12, a first processor 13, a first wireless communication unit 14, a display unit 15, and an audio playing unit 16.

The input unit 11 is for users to input at least one keyword for searching for multimedia files. The first storage unit 12 stores a format supported by the portable device 10. In the embodiment, the format includes a resolution and a coding format.

The first processor 13 is configured to generate a play request signal including at least one input keyword in response to the input from the input unit 11. In addition, transmit the play request signal including the at least one keyword and the stored format to the set-top box 20 through the first wireless communication unit 14, to request the set-top box 20 to search desired multimedia files which satisfy the format supported by the portable device 10. The first processor 13 receives at least one multimedia file from the set-top box 20 if the set-top box 20 searches the at least one multimedia file in the network server 30, and determines the number of the at least one multimedia file is one or more than one. In this embodiment, the at least one multimedia file received from the set-top box 20 is streaming media, thus the set-top box 20 can transmit already downloaded portion of the at least one multimedia file to the device 10 to display/play during the downloading of the at least one searched multimedia file. If only one multimedia file is received, the first processor 13 controls the display unit 15 and/or the audio playing unit 16 to display/play the multimedia file. If more than one multimedia files are received, the first processor 13 controls the display unit 15 to display the multimedia files in a multi-widow mode for users to preview and select. The first processor 13 further transmits a selecting signal including an identifying code for identifying the selected multimedia file to the set-top box 20 in response to the user selection, to direct the set-top box 20 to continue downloading the selected multimedia file, and stop downloading the other searched multimedia files.

The set-top box 20 includes a network interface 21, a second wireless communication unit 22, a second processor 23, and a second storage unit 24.

The network interface 21 communicates the set-top box 20 with the network server 30. The second wireless communication unit 22 communicates with the first wireless communication unit 14. In the embodiment, the second wireless communication unit 22 and the first wireless communication unit 14 may include any one or more of a BLUETOOTH unit, an infrared unit, a USB interface, and a WI-FI unit, for example.

The second processor 23 receives the play request signal and the format, and searches in the network server 30 according to the format and the input keyword included in the play request signal. If at least one multimedia file is found, the second processor 23 starts to simultaneously download the at least one multimedia file and transmits the already downloaded portion of the at least one multimedia file to the portable device 10 during the downloading of the at least one multimedia file. In the embodiment, the downloaded at least one multimedia file is streaming media. When a selecting signal is received through the second wireless communication unit 22, the second processor 23 continues downloading the multimedia file corresponding to the selected multimedia file and stops downloading the other found multimedia files according to the selecting signal.

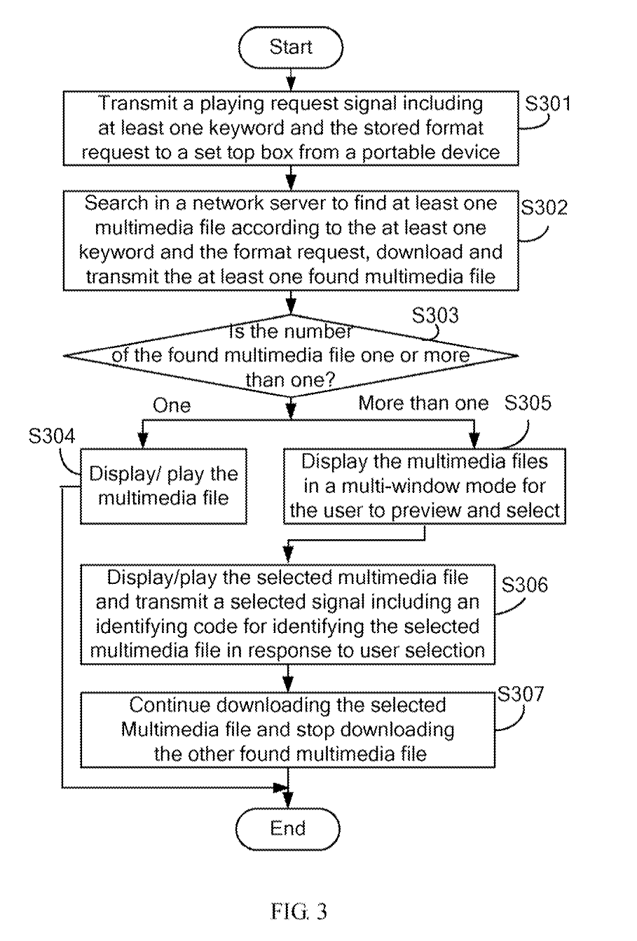

Referring to FIG. 3, a flowchart of a multimedia file playing method implemented in the multimedia file playing system 1 in accordance with an exemplary embodiment is illustrated.

In step S301, the first processor 13 transmits a play request signal including at least one keyword in response to the input from the input unit 11 and the stored format to the set-top box 20 through the first wireless communication unit 14 and the second communication unit 22.

In step S302, the second processor 23 searches the network server 30 according to the input keyword included in the play request signal and the format to find at least one desired multimedia file. While simultaneously downloading the at least one found multimedia file from the network server 30, and transmitting the already downloaded portion of the at least one multimedia file to the portable device 10 during the downloading of the at least one found multimedia file. In the embodiment, the at least one multimedia file is streaming media.

In step S303, the first processor 13 determines the number of the received multimedia file is one or more than one. If one multimedia file is received, the procedure goes to step S304. Otherwise, the procedure goes to step S305.

In step S304, the first processor 13 displays/plays the multimedia file.

In step S305, the first processor 13 displays the multimedia files in the multi-window mode for users to preview and select.

In step S306, the first processor 13 displays/plays the selected multimedia file, and transmits a selected signal including an identifying code for identifying the selected multimedia file to the set-top box 20.

In step S307, the second processor 23 continues downloading the multimedia file corresponding to the selected multimedia file and stops downloading the other multimedia files according to selecting signal.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A multimedia file playing system, comprising:
a set-top box comprising:
a network interface to communicate with a network server;
a first wireless communication unit; and
a first processor; and
at least one portable device each comprising:
an input unit for users to input at least one keyword;
a second wireless communication unit to communicate with the first wireless communication unit; and
a second processor to generate a play request signal including at least one keyword in response to the input from the input unit and transmit the play request signal including at least one keyword to the set-top box;
wherein the first processor searches in the network server according to the at least one input keyword included in the play request signal to find at least one multimedia file, simultaneously downloads the at least one found multimedia file, and transmits already downloaded portion of the at least one multimedia file which being streaming media to the second processor through the first wireless communication unit and the second wireless communication unit; and
the second processor displays/plays the received multimedia files.

2. The multimedia file playing system as described in claim 1, wherein each of the at least one portable device further comprises a storage unit storing a format supported by the portable device, the second processor further transmits the format to the set-top box with the play request signal, and the first processor searches for the multimedia files which satisfy the format in the network server according to at least one keyword.

3. The multimedia file playing system as described in claim 1, wherein the second processor displays/plays the one multimedia file if only one multimedia file is found.

4. The multimedia file playing system as described in claim 1, wherein each of the at least one portable device further comprises a display unit, the second processor displays the more multimedia files in a multi-window mode if more than one multimedia files are found, the second processor plays a selected multimedia file and transmits a selecting signal including an identifying code for identifying the selected multimedia file to the first processor in response to a user selection, and the first processor continues downloading the selected multimedia file and stops downloading the other multimedia files according to the selecting signal.

5. A multimedia file playing method, the multimedia file playing method implemented by a multimedia file playing system, the multimedia file playing system comprising at least one portable device and a set-top box; the at least one portable device comprising an input unit and a first wireless communication unit; the set-top box comprising a network interface and a second wireless communication unit, the method comprising:
generating a play request signal including at least one keyword in response to the input from the input unit;
transmitting the play request signal including at least one keyword to the set-top box through the first wireless communication unit and the second wireless communication unit;
searching in the network server to find at least one multimedia file through the network interface according the at least one keyword recorded in the play request signal;
downloading the found at least one multimedia file which being streaming media from the network server, and transmitting the downloaded portion of the at least one multimedia file to the portable device through the first wireless communication unit and the second wireless communication unit; and
displaying/playing the multimedia files.

6. The multimedia file playing method as described in claim 5, the at least one portable device further comprising a storage unit storing format supported by the portable device, wherein the method further comprises:
transmitting the format to the set-top box with the play request signal through the first wireless communication unit and the second wireless communication unit; and
searching in the network server to find at least one multimedia file according to the at least one keyword included in the play request signal and the format.

7. The multimedia file playing method as described in claim 5, wherein the method further comprises:
displaying/playing the multimedia file when only one multimedia file is received by the at least one portable device.

8. The multimedia file playing method as described in claim 5, the at least one portable device further comprising a display unit, wherein the method further comprises:
controlling the display unit to display the multimedia files in a multi-window mode for the user to preview and select when more than one multimedia files are received, playing a selected multimedia file and generating a selected signal including an identifying code for identifying the selected multimedia file in response to user selects, transmitting the selected signal including an identifying code for identifying the selected multimedia file to the set-top box; and
continuing downloading the multimedia file and stopping downloading the other multimedia files according to the selected signal.

9. A set-top box comprising:
a network interface, through which the set-top box communicating with a network server;
a wireless communication unit, through which the set-top box communicating with at least one portable device; and
a processor to receive a play request signal including at least one keyword from the at least one portable device through the wireless communication unit, search in the network server to find at least one multimedia file through the network interface according to the at least one keyword included in the play request signal, download the found at least one multimedia file which being streaming media from the network server, and transmit the downloaded portion of the at least one multimedia file to the portable device through the wireless communication unit.

10. The set-top box as described in claim 9, wherein the processor further receives format and the play request signal through the wireless communication unit, and searches in the network server to find at least one multimedia file according to the format and the at least one keyword included in the play request signal.

11. The set-top box as described in claim 9, wherein if the processor receives a selected signal including an identifying code for identifying an selected multimedia file from the portable device, the processor continues downloading the selected multimedia file and stops downloading the other multimedia files according to the selecting signal.
